(19) United States
(12) Patent Application Publication
(10) Pub. No.: US 2025/0377077 A1
(43) Pub. Date: Dec. 11, 2025

(54) CRYOLIQUID EXPANDER

(71) Applicant: 2B HOLDINGS, LLC, WEATHERFORD, TX (US)

(72) Inventor: OLEKSANDR V. MATORIN, CARROLLTON, TX (US)

(73) Assignee: 2B HOLDINGS, LLC, WEATHERFORD, TX (US)

(21) Appl. No.: 19/227,196

(22) Filed: Jun. 3, 2025

Related U.S. Application Data
(60) Provisional application No. 63/657,221, filed on Jun. 7, 2024.

(51) Int. Cl. F17C 7/04; F17C 13/04

(52) U.S. Cl. CPC F17C 7/04; F17C 13/04; F17C 2221/014; F17C 2221/031; F17C 2223/0161; F17C 2225/0123; F17C 2227/0135; F17C 2250/032; F17C 2250/0439; F17C 2250/0636; F17C 2265/025; F17C 2270/02

(57) ABSTRACT

A liquified gas expansion system for cryotherapy establishes a continuous flow of cooled gases to a treatment environment. Sensors within the treatment environment measure temperature at least at the upper and lower portions of the chamber. Using data from each sensor a liquified gas expansion valve controls the expansion of a liquified gas in an expansion chamber. A treatment environment valve and an ambient environment valve are manipulated to control a combination of ambient atmosphere to expanding liquified gas impacting the pressure and flow volume within the expansion chamber. The combined expanded liquified gas in its gaseous form and ambient atmosphere are directed to the treatment environment via the treatment environment valve.

### RELATED APPLICATION

The present application relates to and claims the benefit of priority to United States Provisional Patent Application No. 63/657,221 filed Jun. 7, 2024, which is hereby incorporated by reference in its entirety for all purposes as if fully set forth herein.

### BACKGROUND OF THE INVENTION

### Field of the Invention

Embodiments of the present invention relate, in general, to cryotherapy and more particularly to a system, apparatus and methodology for expansion of a liquified gas in support of a cryotherapy chamber.

### Relevant Background

Cryogenic therapy, also known as cryotherapy, involves the application of extremely cold temperatures to biological tissues for therapeutic purposes. Among the various methods and agents used in cryotherapy, the expansion of nitrogen from its liquid to gaseous state plays a critical role.

Cryotherapy is a popular means by which to treat various ailments. Most systems consist of a cryotherapy machine (a cryochamber) that has includes an internal patient chamber. The internal patient chamber is dimensioned to contain a standing adult from approximately his shoulders down. The chamber is chilled by cryogenic gases, which are generated using a cryogenic liquid source connected to the cryochamber. In operation, the patient chamber is cooled well-below freezing, with an exemplary target temperature being below −230° F. exposing individuals to extremely cold dry air, which is about for about 20 seconds to 4 minutes to lower the skin temperature to about 30 to 45 degrees ° F. Whole-body cryotherapy involves exposing mammals to a nitrogen-cooled environment for 2-5 minutes at temperatures ranging from −110° C. to −160° C. This triggers systemic physiological responses such as vasoconstriction, endorphin release, and reduced inflammation. One of reasonable skill in the relevant art will recognize that the duration of exposure (treatment) is directly related to the size of the mammal. The time of treatment for an elephant would be significantly greater than that of a canine.

Cryotherapy can be applied to human or animal subjects for ailment from chronic conditions such as, but not limited to, chronic pain, sports injuries, inflammation, fatigue, skin conditions etc. To achieve the subzero temperatures required for such treatment two methods are typically used that include liquid nitrogen and refrigerated cold air. Whole body cryotherapy was initially intended for use in a clinical setting to treat patients with conditions such as multiple sclerosis and rheumatoid arthritis, and although such treatment is provided was originally limited to hospitals and medical clinics, it has now been implemented in many spas, and athletic training facilities as well to provide wellness treatment to users. Elite athletes have recently reported using the treatment to alleviate Delayed Onset Muscle Soreness (DOMS) after exercise. In addition, recreational athletes have started to emulate elite athletes in using these treatments after exercise. Reductions in muscle and skin tissue temperature after cold exposure may stimulate cutaneous receptors and excite the sympathetic adrenergic fibers, causing constriction of local arterioles and venules. Consequently, cryotherapy is proved to be effective in relieving soreness, or muscle pain, through reduced muscle metabolism, skin microcirculation, receptor sensitivity and nerve conduction velocity.

Current systems are based on a thermally insulated chamber, cooled by liquid nitrogen or by a special compressor, for example with three-stage cascade compression. Such compressors function on a very specialized technology and differ significantly from standard refrigeration installations. This type of compressor, which has only recently been developed, uses special fluids and involves a high level of consumption and high cost. Moreover, notwithstanding, the time needed to get to the required temperature is still considerable, as going from −60° C. to the treatment temperature of −110° C. can require between three- and four-hours' operation.

Other Cryotherapy units employ the expansion of liquified Nitrogen or a similar liquified gas thereby creating a super cooled gaseous environment. Once formed, the super cooled gases are mixed with ambient air and driven into a treatment chamber by a fan or blower. The speed of the fan is driven by temperature sensors within the treatment area. With treatment complete the cycle repeats. This approach of delivering cytotherapeutic gasses has proven to be problematic. The expansion of liquefied gas to its gaseous form occurs in the presence of a certain degree of moisture. The moisture is supercooled due to the extreme cold of the expanding liquified gas. As the gas is transported to the treatment chamber through the fan or blower rime ice is formed. Rime ice is formed when small, supercooled water droplets freeze on contact with a surface (in this instance the fan blades) which is at a sub-zero centigrade (Celsius) temperature. Because the droplets are small, they freeze almost instantly creating a mixture of tiny ice particles and trapped air. Ice of this type generally forms when the air temperature is between 0 and −20° Centigrade. Clear ice forms generally forms when the air temperature is between 0 and −20° Centigrade when the water content is higher. Eventually the buildup of ice of either type prevents the fan's operation.

Existing indirect cooling systems often lack effective mechanisms to prevent ice buildup on critical components, such as fans or blowers, which can impair their performance and efficiency. There is a need for improved systems that can maintain uniform temperature gradients within the treatment environment while mitigating the risk of ice formation on system components, thereby ensuring safe and consistent cryotherapy treatments.

To address the issue of establishing a continuous flow of cooled gases to the treatment environment with controlled temperature gradients and preventing ice formation on system components, some patents have been developed. For example:
U.S. Pat. No. 10,765,551B1 discloses a system and method for automatically producing and monitoring a cryotherapy session within a chamber. The system includes a plumbing system coupled to the chamber for cooling the chamber, and a central controller operable for initiating the cryotherapy session, determining if the desired temperature has been reached, checking for user commands, and stopping the session after a predetermined time. The central controller also monitors the cooling rate and a heater associated with the cooling rate. However, the patent does not provide a mechanism for precisely controlling temperature gradients within the treatment environment or preventing ice buildup on system components.
U.S. Pat. No. 20,170,000544A1 describes a system and kit for using a low-pressure refrigerant source for a cryotherapy procedure and subcooling a cryotherapy refrigerant. The system includes a fluid reservoir, a fluid flow path with thermal exchange devices, a compressor, a condenser, a reversing valve, and an expansion valve. A third thermal exchange device is configured to be in fluid communication with the cryotherapy console and place a secondary refrigerant within the fluid flow path in thermal communication with the cryotherapy system's refrigerant. However, the patent does not address the issue of establishing controlled temperature gradients within the treatment environment or preventing ice formation on system components such as the airflow driving device.
U.S. Pat. No. 8,715,274B2 describes a method of performing a cryotherapy procedure using a cryotherapy balloon catheter. The method involves regulating the flow of cryogenic fluid to and exhaust from the distal balloon portion during two phases to maintain an initial pressure and subsequently reach a temperature sufficient for delivering therapeutic levels of cryotherapy. However, the method may not address the issue of preventing ice formation on the airflow driving device, which can be mitigated by the user's tech-means of manipulating the mixture of ambient atmospheric air and expanding liquefied gas to achieve a temperature well below −20 Centigrade at the face of the airflow driving device.

Limitations of the prior art include:
Existing cryotherapy systems lack the ability to precisely control and maintain uniform temperature gradients throughout the treatment environment, leading to uneven cooling and potential safety concerns.
The direct exposure to cryogenic gases, such as vaporized liquid nitrogen, in conventional cryotherapy chambers can result in the formation of ice or rime on critical system components, hindering efficient operation and potentially causing damage.
Indirect cooling systems that employ heat exchangers and controlled airflow often struggle to achieve consistent temperature distribution within the treatment chamber, as the cooled air exhibits varying densities at different temperatures, leading to temperature stratification.
Current cryotherapy systems do not incorporate effective mechanisms to prevent ice buildup on crucial components like fans or blowers, which can impair their performance and efficiency over time.

These and other deficiencies of the prior art are addressed by one or more embodiments of the present invention. Additional advantages and novel features of this invention shall be set forth in part in the description that follows, and in part will become apparent to those skilled in the art upon examination of the following specification or may be learned by the practice of the invention. The advantages of the invention may be realized and attained by means of the instrumentalities, combinations, compositions, and methods particularly pointed out in the appended claims.

### SUMMARY OF THE INVENTION

The present invention provides a liquefied gas expansion system for cryotherapy that establishes a continuous flow of cooled gases to a treatment environment with controlled temperature gradients while preventing ice formation on system components. Systems described herein provide for expansion of a liquefied gas for use in a cryotherapy environment that enables effective temperature control, safe indirect cooling, and prevention of ice formation on the airflow driving device.

Precise control over temperature gradients within the treatment environment, ensuring uniform cooling and mitigating potential safety concerns associated with uneven temperature distribution is achieved by one or more embodiments of the present invention. In one embodiment, effective prevention of ice buildup on critical system components, such as the airflow driving device (fan or blower), occurs by manipulating the mixture of ambient atmospheric air and expanding liquefied gas to maintain temperatures well below −20° C. at the face of the airflow driving device while still producing a positive pressure differential to drive the cooled mixture to the treatment environment.

Continuous circulation of the gas mixture, driven by the airflow driving device, facilitates a consistent and stable flow of cooled gases throughout the treatment environment. Moreover, incremental control over the ambient environment valve and treatment environment valve, allows for precise adjustment of the volume ratio of ambient air to expanding liquefied gas, as well as the distribution of the gas mixture to the upper and lower portions of the treatment environment.

Temperature monitoring within the treatment environment through multiple sensors, enables the control system to detect and respond to temperature differentials and gradients, as well as their rates of change, ensuring optimal and consistent cooling conditions. Indeed, the use of sensors within the treatment environment captures temperature differentials, gradients, and rates of change, that, when coupled with the control system, dynamically adjusts various system parameters allowing for real-time adjustment of the cryotherapy conditions, ensuring optimal therapeutic efficacy.

Lastly, separation of the cryogenic gas from the treatment environment, mitigates potential safety risks associated with direct exposure to liquefied gases while still achieving the desired therapeutic effects of cryotherapy. The indirect cooling approach of the present invention, where the liquefied gas is first expanded and then combined with ambient air before being introduced into the treatment environment, mitigates potential safety hazards associated with direct exposure to high concentrations of cryogenic gases, such as nitrogen.

The features and advantages described in this disclosure and in the following detailed description are not all-inclusive. Many additional features and advantages will be apparent to one of ordinary skill in the relevant art in view of the drawings, specification, and claims hereof. Moreover, it should be noted that the language used in the specification has been principally selected for readability and instructional purposes and may not have been selected to delineate or circumscribe the inventive subject matter; reference to the claims is necessary to determine such inventive subject matter.

### BRIEF DESCRIPTION OF THE DRAWINGS

The aforementioned and other features and objects of the present invention and the manner of attaining them will become more apparent, and the invention itself will be best understood, by reference to the following description of one or more embodiments taken in conjunction with the accompanying drawings, wherein:

FIG. 1 shows a high level system diagram for a liquefied gas expansion system for cryotherapy according to one embodiment of the present invention.

FIGS. 2A and 2B shows a flowchart for a methodology for expansion of a liquefied gas system for cryotherapy according to one embodiment of the present invention.

FIGS. 3-10 are images from various point of view of one embodiment of a treatment environment using the liquefied gas expansion system of the present invention.

The Figures depict embodiments of the present invention for purposes of illustration only. Like numbers refer to like elements throughout. In the figures, the sizes of certain lines, layers, components, elements or features may be exaggerated for clarity. One skilled in the art will readily recognize from the following discussion that alternative embodiments of the structures and methods illustrated herein may be employed without departing from the principles of the invention described herein.

### DESCRIPTION OF THE INVENTION

A liquified gas expansion system for cryotherapy establishes a continuous flow of cooled gases to a treatment environment. Sensors within the treatment environment measure temperature at least at the upper and lower portions of the chamber. Using data from various sensors a liquified gas expansion valve controls the expansion of a liquified gas in an expansion chamber. A treatment environment valve and an ambient environment valve are manipulated to control a combination of ambient atmosphere to expanding liquified gas impacting the pressure and flow volume within the expansion chamber. The combined expanded liquified gas in its gaseous form and ambient atmosphere are directed to the treatment environment via the treatment environment valve.

It is an objective of the present invention to overcome the drawbacks in the existing technology and provide a method for establishing a continuous flow of cooled gases to a cryotherapy treatment environment with controlled temperature gradients while preventing ice formation on system components.

Embodiments of the present invention are hereafter described in detail with reference to the accompanying Figures. Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention.

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

The terminology used herein is for the purpose of describing embodiments only and is not intended to be limiting of the invention. As used herein, the singular forms “a,” “an” and “the” are intended to include the plural forms as well, unless the context clearly indicates otherwise. Thus, for example, reference to “a component surface” includes reference to one or more of such surfaces.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be also understood that when an element is referred to as being “on,” “attached” to, “connected” to, “coupled” with, “contacting”, “mounted” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under,” “below,” “lower,” “over,” “upper” and the like, may be used herein for ease of description to describe one element or feature's relationship to another element(s) or feature(s) as illustrated in the figures. It will be understood that the spatially relative terms are intended to encompass different orientations of a device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of “over” and “under”. The device may be otherwise oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only unless specifically indicated otherwise.

Included in the description are flowcharts depicting examples of the methodology which may be used to expand liquified gas for cryotherapy purposes. In the following description, it will be understood that each block of the flowchart illustrations, and combinations of blocks in the flowchart illustrations, can be implemented by computer program instructions. These computer program instructions may be loaded onto a computer or other programmable apparatus to produce a machine such that the instructions that execute on the computer or other programmable apparatus create means for implementing the functions specified in the flowchart block or blocks. These computer program instructions may also be stored in a computer-readable memory that can direct a computer or other programmable apparatus to function in a particular manner such that the instructions stored in the computer-readable memory produce an article of manufacture including instruction means that implement the function specified in the flowchart block or blocks. The computer program instructions may also be loaded onto a computer or other programmable apparatus to cause a series of operational steps to be performed in the computer or on the other programmable apparatus to produce a computer implemented process such that the instructions that execute on the computer or other programmable apparatus provide steps for implementing the functions specified in the flowchart block or blocks.

Accordingly, blocks of the flowchart illustrations support combinations of means for performing the specified functions and combinations of steps for performing the specified functions. It will also be understood that each block of the flowchart illustrations, and combinations of blocks in the flowchart illustrations, can be implemented by special purpose hardware-based computer systems that perform the specified functions or steps, or combinations of special purpose hardware and computer instructions.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

Upon reading this disclosure, those of skill in the art will appreciate still additional alternative structural and functional designs for a system and a process for expansion of liquified gases for cytotherapeutic purposes through the disclosed principles herein. Thus, while embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

In one or more embodiments of the present invention, the expansion of liquid nitrogen into its gaseous form enables the application of extremely cold temperatures to biological tissues for therapeutic purposes. For purposes of the present invention, the physical properties of nitrogen relevant to cryotherapy include:
Chemical Symbol: N₂
Boiling Point: −195.79° C. (77 K) at 1 atm
Latent Heat of Vaporization: 199 KJ/kg.
Density (Liquid at BP): ˜0.807 g/cm³
Expansion Ratio: 1:694 (liquid to gas at 20° C.).
Inertness: Non-toxic, non-flammable, and chemically stable

These properties make nitrogen ideal for use in cryotherapy. When liquid nitrogen (LN2) is exposed to atmospheric pressure, it rapidly vaporizes, absorbing a significant amount of heat and resulting in an extremely cold environment.

The expansion of nitrogen from liquid to gas involves a phase transition characterized by the following thermodynamic steps:
Storage and Containment: LN2 is typically stored in Dewar flasks or cryogenic tanks at pressures just above atmospheric to maintain its liquid state.
Heat Absorption and Vaporization: Upon release, LN2 absorbs thermal energy from its surroundings, initiating vaporization. The large latent heat of vaporization leads to a rapid drop in temperature.
Volume Expansion: Each liter of LN2 produces approximately 694 liters of gaseous nitrogen at room temperature and 1 atm pressure.
Convection and Heat Transfer: The cold nitrogen gas cools the air in the surrounding chamber, transferring thermal energy away from the surface of the mammal's body primarily through convection.

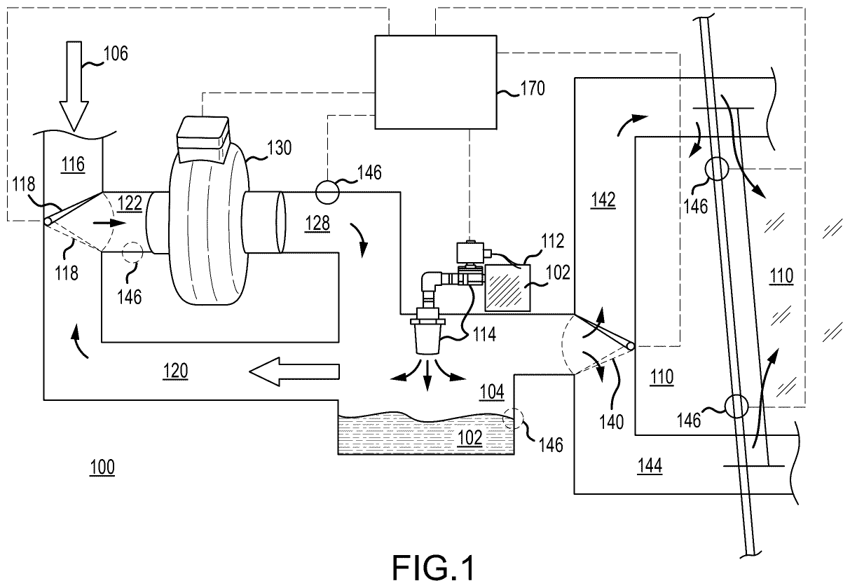

FIG. 1 presents one embodiment of a system 100 for expansion of a liquefied gas for use in a cryotherapy environment. In one embodiment of the present invention the system enables the expansion of a liquified gas 102 in an expansion chamber 104, such as Nitrogen, to establish cryogenic temperatures. The cooled gaseous state of the liquefied gas is combined with ambient air 106 as a temperature control mechanism before it is introduced into a treatment environment 110.

A source of liquefied gas 112 is fluidically coupled to a liquified gas expansion valve 114 directing the resulting expanding liquified gas to enter the expansion chamber 104. The ambient atmospheric air 106 flows through an ambient environment conduit 116 until reaching an ambient environment valve 118. Ambient atmospheric air 106 via an ambient environment conduit 116 is mixed with the expanding liquified gas via a reverse flow conduit 120 at the ambient environment valve 118. The ambient environment valve 118 controls the volume ratio of ambient atmosphere air 106 to existing gases in the expansion chamber directed back to the expansion chamber 104. In one embodiment the ratio is 4:1 expanded liquified gas to ambient air while in another embodiment the ratio is within a range of 3-4:2-1 and while in another embodiment the ratio is in the range of 3.5-4.5:1.5-0.5. The ambient environment valve 118 is incrementally controllable. The ambient environment conduit 116 merges with the reverse flow conduit 120 at the ambient environment valve 118 forming an airflow driving device intake conduit 122 housing a mixture of ambient air and expanding liquified gas. In one embodiment of the present invention the mixture of ambient air and expanding liquified gas is a 1:4 ratio. Said differently the mixture is highly densified expanding liquified gas comprised of substantially 80% nitrogen gas and 20% ambient air. In another embodiment the ratio is within a range of 3-4:2-1 and while in another embodiment the ratio is in the range of 3.5-4.5:1.5-0.5.

An airflow driving device 130 (fan or blower) is interposed between the airflow driving device intake conduit 122 and an airflow driving device exhaust conduit 128. The airflow driving device exhaust conduit 128 is coupled to the expansion chamber 104. Within the airflow driving device exhaust conduit 128 exists a temperature sensor 146 to measure and report on outflow air temperature. An optional temperature sensor may also be in the airflow driving device intake conduit 122. In this embodiment of the present invention a continuous clockwise flow of gas exists from the expansion chamber 104 to the ambient environment valve 118 and through the airflow driving device 130. Indeed, the airflow driving device 130 drives the internal continuous flow of the mixture of expanding liquefied gas and ambient atmospheric air toward the reservoir 102 of liquid nitrogen. The interaction of the mixture of expanding liquefied gas and ambient atmospheric air and liquid nitrogen maintains a non-homogenous state within the expansion chamber 104. In one embodiment the mixture of expanding liquefied gas and ambient atmospheric air is directed vertically down toward liquid gas (nitrogen) residing at the bottom of the expansion chamber 104.

The non-homogenous state evokes liquid nitrogen to vaporize raising the pressure within the chamber and dropping the temperature. A sensor 146 monitors the state or level of liquid nitrogen in the expansion chamber driving the processor to command the release of additional nitrogen from nitrogen source 112. Significantly the mixture (quantity/volume) of ambient atmospheric air and expanding liquified gas are manipulated to provide a mixture at the face of the airflow driving device 130 well below −20° Centigrade thereby inhibiting the formation of ice, rime or clear, on the blades of the airflow driving device 130 while simultaneously providing sufficient positive pressure to direct the mixture of ambient atmospheric air and expanding liquified gas toward the treatment environment 110.

A treatment environment valve 140 is also coupled to the expansion chamber 104 enabling the mixture of expanding liquified gas and ambient atmosphere air to exit the expansion chamber 104 and be directed to the treatment environment 110 via an upper treatment environment conduit 142 and a lower treatment environment conduit 144. The treatment environment valve 140 is incrementally controllable to manipulate the volume of expansion chamber gases delivered to the upper treatment environment conduit 142 and lower treatment environment conduit 144. The present invention capitalizes on the cooling nature of expanding LN2. While the gasification of LN2 can elevate the internal pressure within the expansion chamber 104, driving the cooled gas into a treatment environment 110 by way of increased LN2 pressurization would be inefficient. Conversely, gasification of a sufficient amount of LN2 to meet the cooling need of the cryotherapy device of the present invention, is insufficient to reliably drive the gas into a treatment environment 110. The airflow driving device 130 conveys a controlled volume of the cooled gas mixture into the treatment environment while maintaining temperature at the face of the fan at or below −20 degrees Centigrade.

The upper treatment environment conduit 142 and lower treatment environment conduit 144 transport the mixture of expanding liquified gas and ambient atmosphere air to the treatment environment 110. While FIG. 1 presents an upper and lower treatment environment conduit 142, 144 one of reasonable skill in the art will recognize that multiple variations and distribution conduits can be crafted to deliver the expanding liquified gaseous mixture to the treatment environment. Furthermore, the conduits can include vortice generators or similar perturbations to enhance airflow mixing. Within the treatment environment exists two or more sensors 146 to provide a distribution or gradient of temperature within the treatment environment. As one of reasonable skill in the relevant art can appreciate, cryogenically cooled gasses vary in density. Colder portions of the gas sink to the bottom of the treatment environment 110 while warmer portions of the mixture of expanding liquified gas and ambient atmosphere air rise. Accordingly, the temperature in the upper portions of the treatment environment 110 are likely higher than the lower portions of the treatment environment.

Sensors 146 within the treatment environment capture the temperature differential and/or gradients as well as the rate of change of those gradients. Data with respect to the temperature gradients/differential/rates of change is/are directed to a control system 170. The control system 170 thereafter sends commands to the ambient environment valve 118, the treatment environment valve 140, airflow driving device 130 and the liquified gas expansion valve 114 to manipulate the system 110 to provide optimal cryotherapy temperatures within the treatment environment 110. In other embodiments of the present invention additional sensors are installed to provide operational data. Sensors may be located within, among others, the various conduits, valve locations, the expansion chamber, intersections, and the airflow driving device. The sensors may measure environmental attributes including temperature, pressure, and humidity.

FIG. 1 depicts the various components and their interconnections within the system. As described herein, the main components shown in the diagram include: 1. A source of liquefied gas (112) connected to a liquefied gas expansion valve (114) that directs the expanding liquified gas into an expansion chamber (104). 2. An ambient air inlet (106) that flows through an ambient environment conduit (116) and an ambient environment valve (118), where it mixes with the expanding liquified gas from the reverse flow conduit (120). 3. An airflow driving device (130), such as a fan or blower, that takes in the mixture of ambient air and expanding liquified gas through an intake conduit (122) and expels it through an exhaust conduit (128) back into the expansion chamber (104). 4. A treatment environment valve (140) connected to the expansion chamber (104), allowing the gas mixture to flow into an upper treatment environment conduit (142) and a lower treatment environment conduit (144) leading to the treatment environment (110). 5. Temperature sensors (146) are present in various locations, including the airflow driving device exhaust conduit (128) and the treatment environment (110), to measure and monitor temperatures. 6. A control system (170) that receives data from the temperature sensors (146) and sends commands to the valves (114, 118, 140) and the airflow driving device (130) to manipulate and optimize the cryotherapy temperatures within the treatment environment (110). FIG. 1 illustrates a technical solution for controlling and delivering a cooled gas mixture, derived from a liquefied gas source and ambient air to a cryotherapy treatment environment while maintaining desired temperature conditions through a feedback control system.

In one version of the present invention the liquified gas is Nitrogen. One of reasonable skill in the relevant art will appreciate that the expansion of other liquefied gasses can produce cryogenic environments. In most instances Nitrogen is selected as the media of choice due to its inert characteristics however other applications may find that gasses such as Oxygen, Hydrogen, Helium, Carbon Dioxide, Argon, Krypton, Xenon, and Radon. Compounds of Krypton, Xenon and Radon, while viable for cooling properties, are reactive and unlikely to be utilized for therapeutic purposes.

The expansion of the liquified gas to establish a cryogenic treatment environment will result in temperatures as low as −200° C. Accordingly the material selected for the treatment environment, the conduits, the expansion chamber, and the like must withstand thermal stress resulting from repetitive cooling and heating. In one versions of the present invention high grade stainless steel is used while in other embodiments composite structures, or combinations thereof may be used to achieve the desire results. All are contemplated in various embodiments of the present invention.

One embodiment of the present invention is to provide cryo-stimulation to mammalian bodies. To do so temperature control within the treatment environment is critical. The changing of the state liquid to gas is a thermodynamic event. Heat is absorbed resulting in a lower temperature in the environment. The degree of temperature drop is directly related to the degree of absorption or ratio of expansion of the liquid as it achieves its gaseous form. Liquid Nitrogen expands at a rate of 1:694 meaning that the temperature drop and pressure differential is significant. In one embodiment of the present invention air flow is directed to the treatment environment using differential pressure and flow volume. The degree of delivery to various portions of the treatment environment is controlled via the treatment environment valve in combination with, in one embodiment of the present invention, a differential pressure gradient. In other embodiments additional air flow drivers can be used to facilitate delivery of the cooled gasses to the treatment environment. In yet another embodiment, the airflow driver can be directed to increase or decrease the pressure in the system. Additionally, the pressure can be controlled by the quantity of the liquid gas injected into the expansion chamber as it interacts with ambient air.

Another feature of the present invention is a continual mixing of the gaseous form of the chosen liquefied gas and ambient air to prevent the formation of ice crystals. As discussed herein, the creation of ice crystals inhibits the reliability and functionality of cryotherapy devices. The embodiments of the present invention address this failing of the prior art by establishing a continual internal flow of super cooled gas. The present invention creates an air flow using the airflow driving device prior to the introduction of liquid gas. With a circulatory airflow established liquified gas is introduced. The expansion of the liquified gas increases the internal pressure enabling super cooled gas to be transported to the treatment environment. It is significant to note that the airflow driving device is for internal circulation only and not for delivering cooled gases the treatment environment. Super cooled gases are driven to the treatment environment from a pressure differential developed by the expansion of the liquified gas.

In another embodiment of the present invention, system for expansion of a liquefied gas for use in a cryotherapy environment comprises a source of liquefied nitrogen 112 fluidically coupled to a liquified gas expansion valve 114. The liquified gas expansion valve 114 directs the resulting expanding nitrogen gas to enter an expansion chamber 104. Ambient atmospheric air 106 flows through an ambient environment conduit 116 until reaching an incrementally controllable ambient environment valve 118, where it is mixed with the expanding nitrogen gas via a reverse flow conduit 120. The ambient environment valve 118 controls the volume ratio of ambient atmosphere air 106 to existing gases in the expansion chamber 104. The mixture is thereafter directed back to the expansion chamber 104 vertically to cause a direct interaction with the mixture of ambient air and expanding liquified gas and the surface of the liquified gas residing in the bottom of the expansion chamber. Indeed, the flow of returning gases through the airflow driving device exhaust conduit 128 is substantially perpendicular to the surface of the liquified gas 102 residing in the bottom of the expansion chamber 104.

An airflow driving device 130, such as a fan or blower, is interposed between an airflow driving device intake conduit 122 and an airflow driving device exhaust conduit 128 coupled to the expansion chamber 104. The airflow driving device exhaust conduit 128 comprises a temperature sensor 146 to measure and report on outflow air temperature. A treatment environment valve 140, coupled to the expansion chamber 104, enables the mixture of expanding liquefied nitrogen gas and ambient atmosphere air to exit the expansion chamber 104 and be directed to a treatment environment 110 via an upper treatment environment conduit 142 and a lower treatment environment conduit 144. The treatment environment valve 140 is incrementally controllable to manipulate the volume of expansion chamber gases delivered to the upper treatment environment conduit 142 and lower treatment environment conduit 144.

The treatment environment 110 comprises two or more sensors 146 to provide a distribution or gradient of temperature within the treatment environment 110. A control system 170 receives data from the sensors 146 regarding temperature differentials, gradients, and rates of change, and sends commands to the ambient environment valve 118, treatment environment valve 140, airflow driving device 130, and liquified gas expansion valve 114 to manipulate the system and provide optimal cryotherapy temperatures within the treatment environment 110. The mixture of ambient atmospheric air 106 and expanding liquefied nitrogen gas is manipulated to provide a mixture at the face of the airflow driving device 130 well below −20 Centigrade, thereby inhibiting the formation of ice, rime or clear, on the blades of the airflow driving device 130.

In yet another embodiment of the present invention, a system for expansion of a liquefied gas for use in a cryotherapy environment comprises a source of liquefied nitrogen 112 fluidically coupled to a liquified gas expansion valve 114 directing the resulting expanding nitrogen gas to enter an expansion chamber 104. The liquefied nitrogen is preconditioned by chilling it to a temperature of −25° C. prior to delivery to the liquified gas expansion valve 114 to enhance the conditioning effect of the ambient air flowed over the expansion chamber 104 and heat exchanger. The liquified gas expansion valve 114 is provided with fins to further enhance heat transfer.

Ambient atmospheric air 106 flows through an ambient environment conduit 116 until reaching an incrementally controllable ambient environment valve 118, where it is mixed with the expanding nitrogen gas via a reverse flow conduit 120. The ambient environment valve 118 controls the volume ratio of ambient atmosphere air 106 to existing gases in the expansion chamber 104 directed back to the expansion chamber 104. An airflow driving device 130, such as a fan or blower, is interposed between an airflow driving device intake conduit 122 and an airflow driving device exhaust conduit 128 coupled to the expansion chamber 104. The airflow driving device exhaust conduit 128 comprises a temperature sensor 146 to measure and report on outflow air temperature.

A treatment environment valve 140, coupled to the expansion chamber 104, enables the mixture of expanding liquefied nitrogen gas and ambient atmosphere air to exit the expansion chamber 104 and be directed to the treatment environment 110 via an upper treatment environment conduit 142 and a lower treatment environment conduit 144. The treatment environment valve 140 is incrementally controllable to manipulate the volume of expansion chamber gases delivered to the upper treatment environment conduit 142 and lower treatment environment conduit 144. The treatment environment 110 comprises two or more sensors 146 to provide a distribution or gradient of temperature within the treatment environment 110.

A control system 170 receives data from the sensors 146 regarding temperature differentials, gradients, and rates of change, and sends commands to the ambient environment valve 118, treatment environment valve 140, airflow driving device 130, and liquified gas expansion valve 114 to manipulate the system and provide optimal cryotherapy temperatures within the treatment environment 110. The system further comprises a heater installed in the recirculation air flow to clean and defrost the treatment environment 110 after use, allowing water to be drained safely from the treatment environment 110 and not leaving any residue in the patient area. A temperature sensor is also provided to detect a nitrogen exhaust temperature in the airflow driving device exhaust conduit 128 to enable the control system 170 to perform a safety shutdown if the nitrogen exhaust temperature drops below a predetermined value.

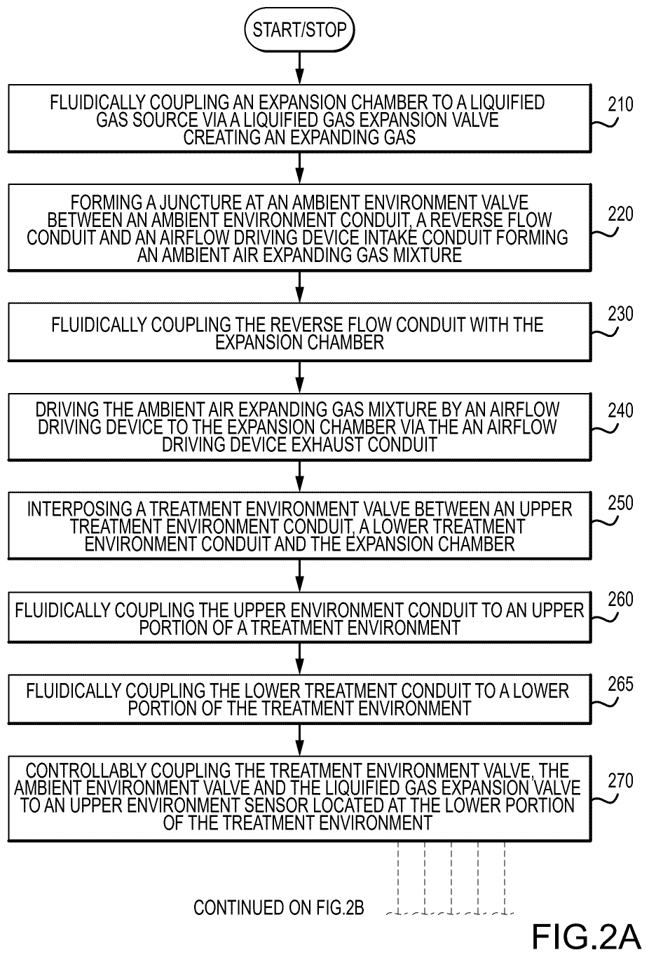

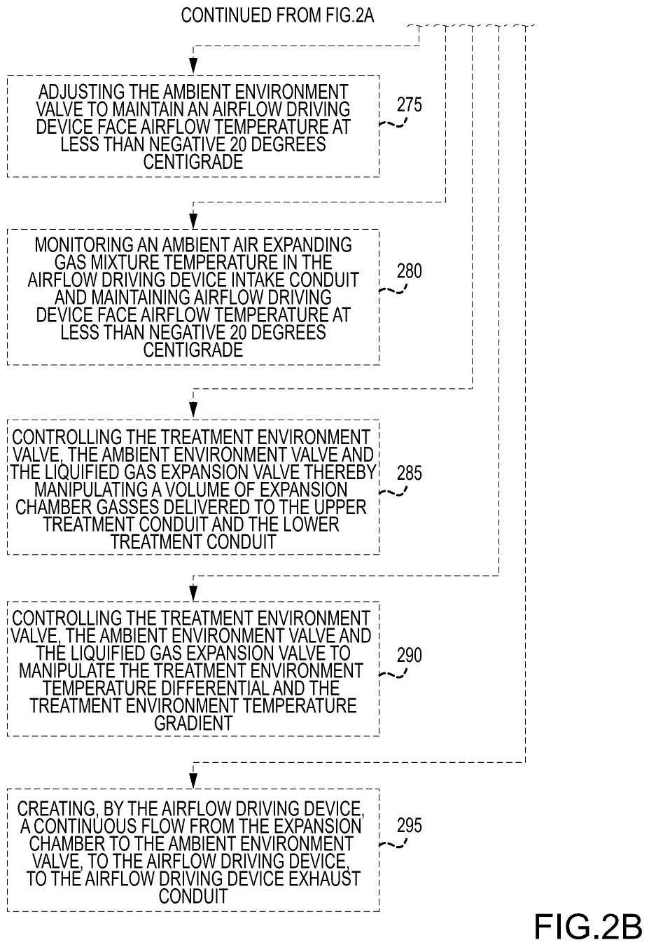

With attention to FIGS. 2A and 2B, one or more embodiments of the present invention provide a method for establishing a continuous flow of cooled gases to a cryotherapy treatment environment with controlled temperature gradients and preventing ice formation on system components. The invention controls the expansion of a liquefied gas into an expansion chamber using a liquefied gas expansion valve and thereafter mixes the expanding liquified gas with ambient air at an ambient environment valve before the combined mixture enters an airflow driving device. The gas mixture circulates continuously through and by the airflow driving device at a fan face temperature of less than 20 degrees Centigrade.

One embodiment of the present invention directs the expansion of liquefied gas 102, such as nitrogen, into the expansion chamber 104 using the liquefied gas expansion valve 114. a source of liquefied gas 112 at a pressure ranging from 100 to 130 psig is directed to the liquefied gas expansion valve 114. The liquefied gas 102 expands into a gaseous state within the expansion chamber 104 through the liquefied gas expansion valve 114, with the expansion chamber 104 maintained at a temperature between −150° C. and −180.

The present invention monitors the temperature of the expanding liquified gas within the expansion chamber 104 using a temperature sensor 146 positioned within the expansion chamber 104.

Ambient air 106 is mixed with the expanding liquified gas from the expansion chamber 104 at the ambient environment valve 118 before entering the airflow driving device 130. In one version of the present invention ambient atmospheric air 106 at a temperature ranging from 15° C. to 25° C. travels through an ambient environment conduit 116 and merges, at the ambient environment valve 118, with the gases in the reverse flow conduit 120 from the expansion chamber 104. The present invention incrementally controls the ambient environment valve 118 to adjust the volume ratio of ambient air 106 to the expanding liquified gas from the expansion chamber 104, with the ratio ranging from 1:1 to 1:5.

The gas mixture continuously circulates using the airflow driving device 130 such as a centrifugal fan or blower, positioned between the intake conduit 122 and the exhaust conduit 128.

The temperature of the gas mixture at the exhaust conduit 128 is monitored using a temperature sensor 146, with the temperature maintained, in one embodiment, between −40° C. and −80° C. The volume ratio of ambient air 106 and expanding liquefied gas 102 is controlled to maintain a temperature below −20° C. at the face of the airflow driving device 130, preventing ice formation on the blades.

The present invention further controls the gas mixture to the upper treatment environment conduit 142 and lower treatment environment conduit 144 leading to the treatment environment 110 using the treatment environment valve 140. The volume of the gas mixture delivered to the upper treatment environment conduit 142 and lower treatment environment conduit 144 varies with the ratio ranging, in one embodiment, from 1:1 to 1:3.

The temperature gradients within the treatment environment 110 are monitored using multiple temperature sensors 146 positioned at various heights within the treatment environment 110, with at least one sensor 146 located in the upper portion and one sensor 146 located in the lower portion of the treatment environment 110.

The temperature gradient data is transmitted from the temperature sensors 146 to a control system 170 which adjusts the liquefied gas expansion valve 114, ambient environment valve 118, and treatment environment valve 140, based on the temperature gradient data, to maintain desired cooling conditions within the treatment environment 110. In one embodiment the temperature in the treatment environment 110 ranges from −100° C. to −150° C. in the lower portion and −60° C. to −90° C. in the upper.

In another embodiment of the present invention a liquefied gas expansion system for cryotherapy includes an expansion chamber 104, a liquefied gas expansion valve 114, an ambient environment valve 118, an airflow driving device 130, a treatment environment valve 140, upper and lower treatment environment conduits 142, 144, and temperature sensors 146 within a treatment environment 110.

The methodology for expanding a liquefied gas expansion system for cryotherapy includes controlling the expansion 210 of a liquefied gas 102 into the expansion chamber 104 using the liquefied gas expansion valve 114. The source of liquefied gas 112 at a pressure ranging from 80 to 120 psig is directed to the liquefied gas expansion valve 114. The liquefied gas 102 is expanded into a gaseous state within the expansion chamber 104 through the liquefied gas expansion valve 114, with the expansion chamber 104 maintained at a temperature between −160° C. and −190° C.

The process continues by monitoring the temperature of the expanding liquified gas within the expansion chamber 104 using a temperature sensor 146 positioned within the expansion chamber 104. Thereafter, ambient air 106 is mixed 220 with the expanding liquified gas from the expansion chamber 104 using the ambient environment valve 118 before the mixture enters the airflow driving device 130.

Specifically, ambient atmospheric air 106 is introduced, in one embodiment, at a temperature ranging from 10° C. to 30° C. through an ambient environment conduit 116. The ambient environment conduit 116 merges with a reverse flow conduit 120 which is fluidically coupled 230 with the expansion chamber 104 at the ambient environment valve 118. The process then incrementally controls the ambient environment valve 118 to adjust the volume ratio of ambient air 106 to the expanding liquified gas from the expansion chamber 104, with the ratio ranging from 1:2 to 1:6 while monitoring the temperature of the gas mixture.

By positioning the airflow driving device 130, such as an axial fan or blower, between an intake conduit 122 and an exhaust conduit 128 and coupling the intake conduit 122 to the ambient environment valve 118 and the exhaust conduit 128 to the expansion chamber 104, the gas mixture circulates 240 continuously using the airflow driving device 130. The volume ratio of ambient air 106 and expanding liquefied gas 102 is manipulated to maintain a temperature between −20° C. and −25° C. at the face of the airflow driving device 130, preventing ice formation on the blades.

The flow of the gas mixture is controlled to the upper treatment environment conduit 142 and lower treatment environment conduit 144 using the treatment environment valve 140 which is interposed 250 between the upper and lower treatment environment conduits 142, 144 and the expansion chamber 104. The upper treatment environment conduit 142 and lower treatment environment conduit 144 are each respectively fluidically coupled 260, 265 to the treatment environment.

In one embodiment of the present invention the process incrementally controls 270 the treatment environment valve 140 to adjust the volume of the gas mixture delivered to the upper treatment environment conduit 142 and lower treatment environment conduit 144, with the ratio ranging from 1:2 to 1:4 while monitoring the temperature gradients within the treatment environment 110 using multiple temperature sensors 146 positioned at various heights within the treatment environment 110. At least two sensors 146 are in the upper portion and two sensors 146 are in the lower portion of the treatment environment 110.

The process further transmits temperature gradient data from the temperature sensors 146 to a control system 170 which, using said data, adjusts the liquefied gas expansion valve 114, ambient environment valve 118, and treatment environment valve 140 to maintain desired cooling conditions within the treatment environment 110, with the temperature ranging from, in one embodiment, −110° C. to −160° C. in the lower portion and −70° C. to −100° C. in the upper portion of the treatment environment 110.

In other embodiments of the present invention the ambient environment valve is adjusted 275 to maintain an airflow driving device face airflow temperature at less than negative 20 degrees Centigrade. Similarly, the ambient air expanding liquified gas mixture temperature in the airflow driving device intake conduit is monitored 280 and maintaining airflow driving device face airflow temperature at less than negative 20 degrees Centigrade.

To maintain the proper temperature gradients within the treatment environment and to maintain pressure and temperature within the expansion chamber, data from both the upper environment sensor located in the upper portion of the treatment environment and the lower environment sensor located in the lower portion of the treatment is received 285 at and processes by the processor.

The processor also executes instructions controlling 290 the treatment environment valve, the ambient environment valve and the liquified gas expansion valve thereby manipulating a volume of expansion chamber gasses delivered to the upper treatment conduit and the lower treatment conduit.

By controlling the ambient environment value, the present invention creates a continuous flow of the ambient air expanding liquified gas mixture from the expansion chamber to the ambient environment valve, to the airflow driving device, to the airflow driving device exhaust conduit.

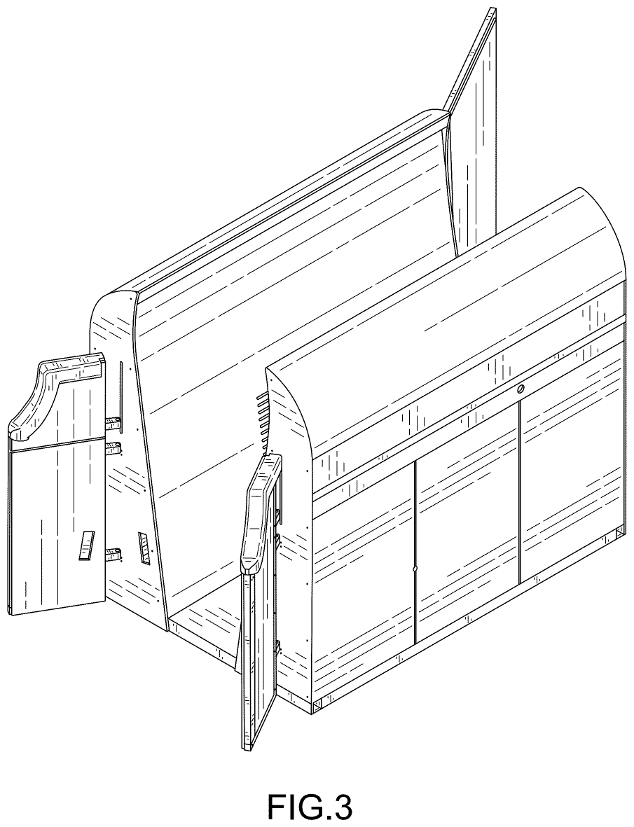

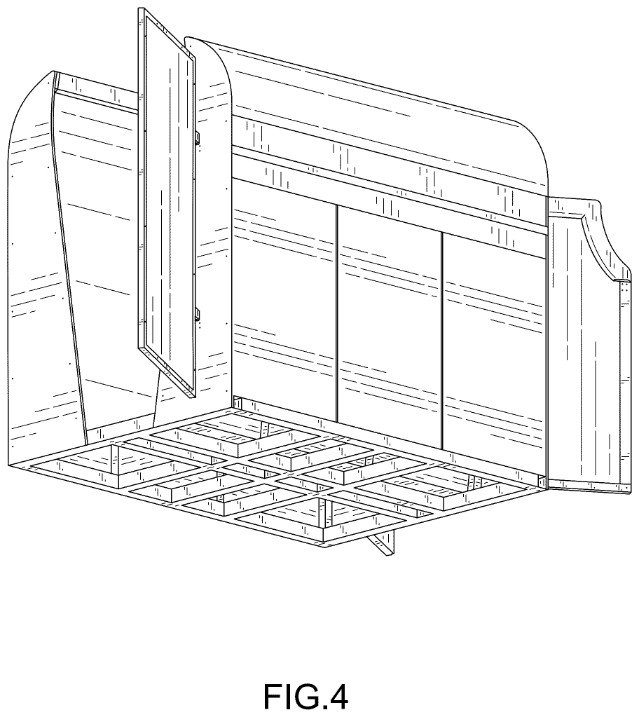

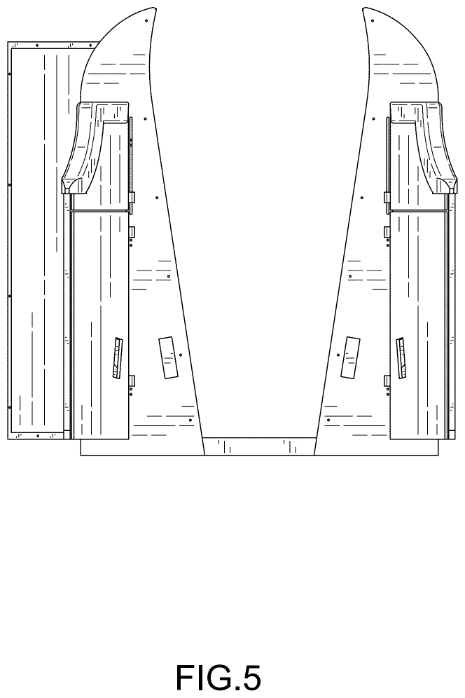

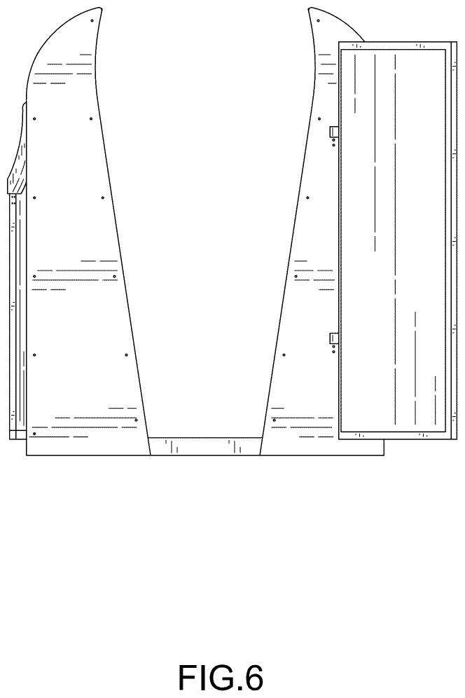

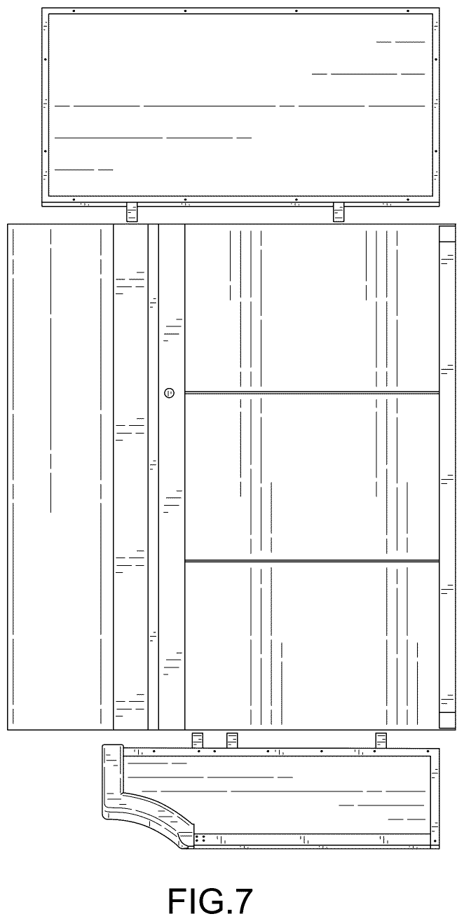

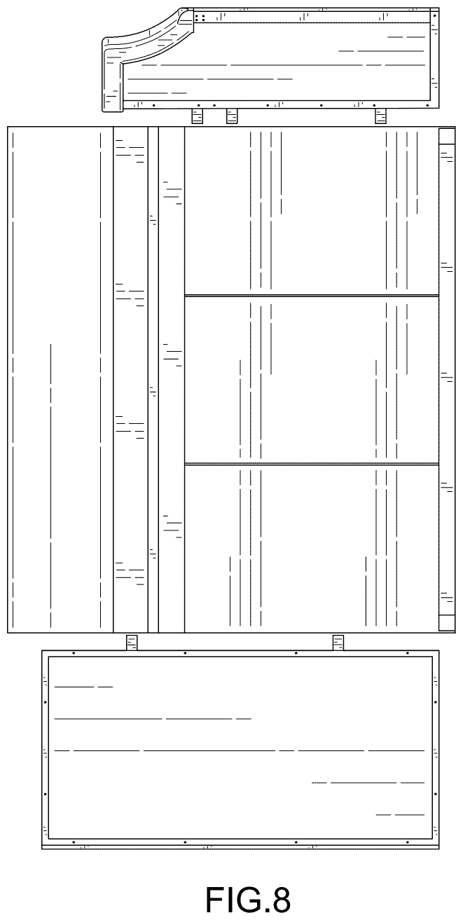

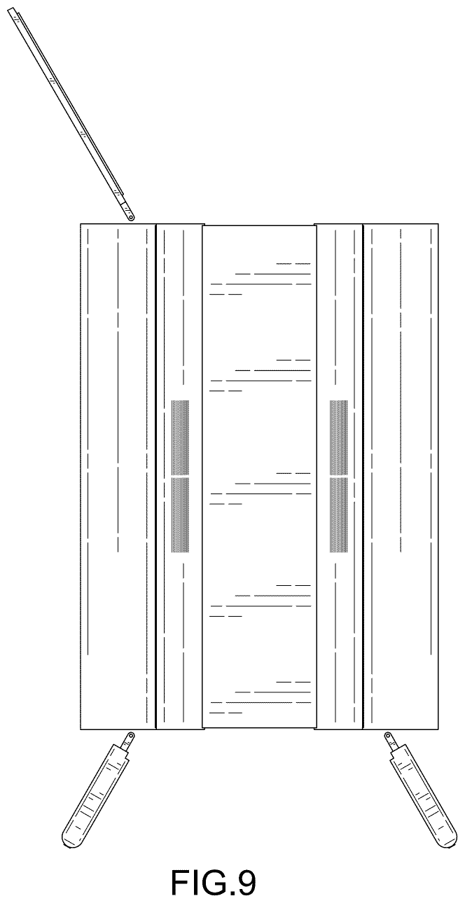

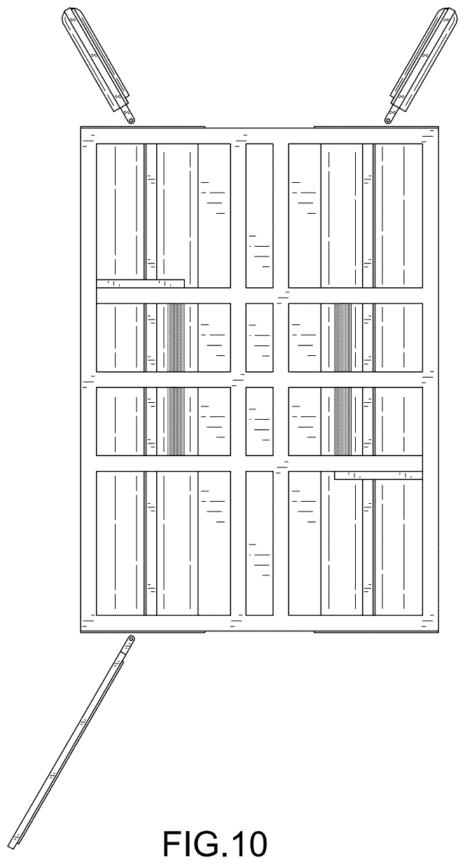

Another feature of the present invention is the design of the treatment environment. FIGS. 3-10 present various views of one embodiment of a treatment environment for cryotherapy using liquified gas expansion. The environment shown in FIGS. 3-10 are a treatment environment for equine patients (horses). The environment allows for a horse to enter the environment from the back and reside in a semi-confined area with the horse's head and neck extending from the front of the environment. Doors at the rear and front allow for the horse to step through the environment. The back doors swing shut to close the rear of the environment and the front doors can swing open to allow the horse to exit upon the cycle's completion.

The interior of the treatment environment tapers longitudinally inward from the top of the treatment environment to the bottom to where the walls intersect with the floor. There is no ceiling or roof in this embodiment. The floor is wide enough for the horse to stand comfortably. Each wall includes a plurality of vents through which the gaseous form of the liquified gas enters the treatment environment. Sensor are located throughout the environment to identify temperatures at each sensor location, rate of temperature change and various temperature gradients including temperature gradients from high to low and from front to back.

In one embodiment liquefied nitrogen is used as the expansive gas. Gaseous nitrogen is slightly less dense than air. At room temperature, nitrogen's density is approximately 1.250 kg/m³, while air's density is around 1.293 kg/m³. This means that nitrogen is slightly lighter than air and tends to rise. However, when nitrogen is cold it becomes denser than air and can settle in low areas. Liquid nitrogen boils (vaporizes) at approximately −196 degrees Centigrade. Accordingly, nitrogen in its recently changed gaseous state is extremely cold and will settle to the bottom of a room or environment.

The treatment environment of the present invention capitalizes on the fact that cold gaseous nitrogen is denser that air allowing a temperature gradient to be created in the treatment environment for optimal cryotherapy conditions.

An exemplary system for implementing the invention includes a general purpose computing device such as the form of a conventional personal computer, a personal communication device or the like, including a processing unit, a system memory, and a system bus that couples various system components, including the system memory to the processing unit. The system bus may be any of several types of bus structures including a memory bus or memory controller, a peripheral bus, and a local bus using any of a variety of bus architectures. The system memory generally includes read-only memory (ROM) and random access memory (RAM). A basic input/output system (BIOS), containing the basic routines that help to transfer information between elements within the personal computer, such as during start-up, is stored in ROM. The personal computer may further include a hard disk drive for reading from and writing to a hard disk, a magnetic disk drive for reading from or writing to a removable magnetic disk. The hard disk drive and magnetic disk drive are connected to the system bus by a hard disk drive interface and a magnetic disk drive interface, respectively. The drives and their associated computer-readable media provide non-volatile storage of computer readable instructions, data structures, program modules and other data for the personal computer. Although the exemplary environment described herein employs a hard disk and a removable magnetic disk, it should be appreciated by those skilled in the art that other types of computer readable media which can store data that is accessible by a computer may also be used in the exemplary operating environment.

As will be understood by those familiar with the art, the invention may be embodied in other specific forms without departing from the spirit or essential characteristics thereof. Likewise, the naming and division of the modules, managers, functions, systems, engines, layers, features, attributes, methodologies, and other aspects are not mandatory or significant, and the mechanisms that implement the invention or its features may have different names, divisions, and/or formats. Furthermore, as will be apparent to one of ordinary skill in the relevant art, the modules, managers, functions, systems, engines, layers, features, attributes, methodologies, and other aspects of the invention can be implemented as software, hardware, firmware, or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment. Accordingly, the disclosure of the present invention is intended to be illustrative, but not limiting, of the scope of the invention, which is set forth in the following claims.

The present invention provides a system for expansion of a liquefied gas for use in a cryotherapy environment. The system comprises a source of liquefied gas fluidically coupled to a liquified gas expansion valve directing the resulting expanding liquified gas to enter an expansion chamber.

Ambient atmospheric air flows through an ambient environment conduit until reaching an ambient environment valve, where it is mixed with the expanding liquified gas via a reverse flow conduit. The ambient environment valve controls the volume ratio of ambient atmosphere air to existing gases in the expansion chamber directed back to the expansion chamber and is incrementally controllable.

An airflow driving device is interposed between an airflow driving device intake conduit and an airflow driving device exhaust conduit coupled to the expansion chamber. The airflow driving device exhaust conduit comprises a temperature sensor to measure and report on outflow air temperature. An optional temperature sensor is in the intake conduit and report on airflow temperature at the face of the airflow driving device.

The mixture of ambient atmospheric air and expanding liquified gas is manipulated to provide a mixture at the face of the airflow driving device well below −20 Centigrade, thereby inhibiting the formation of ice, rime or clear, on the blades of the airflow driving device. The liquefied gas may be preconditioned by chilling it to a temperature, for example, of −25° C. prior to delivery to the pressure reducer to enhance the conditioning effect of the microenvironment air flowed over the pressure reducer and heat exchanger. The pressure reducer can also be provided with fins to further enhance heat transfer.

A treatment environment valve coupled to the expansion chamber enables the mixture of expanding liquified gas and ambient atmosphere air to exit the expansion chamber and be directed to a treatment environment via upper and lower treatment environment conduits. The treatment environment valve is incrementally controllable to manipulate the volume of expansion chamber gases delivered to the upper and lower treatment environment conduits.

The treatment environment comprises two or more sensors to provide a distribution or gradient of temperature within the treatment environment. A control system receives data from sensors regarding temperature differentials, gradients, and rates of change, and sends commands to the ambient environment valve, treatment environment valve, airflow driving device, and liquified gas expansion valve to manipulate the system and provide optimal cryotherapy temperatures within the treatment environment.

The system may further comprise a heater installed in the recirculation air flow to clean and defrost the therapy chamber after use, allowing water to be drained safely from the chamber and not leaving any residue in the patient area. A temperature sensor may also be provided to detect a nitrogen exhaust temperature in the nitrogen exhaust conduit to enable the controller to perform a safety shutdown if the nitrogen exhaust temperature drops below a predetermined value

While there have been described above the principles of the present invention in conjunction with a liquefied gas expansion system for cryotherapy, it is to be clearly understood that the foregoing description is made only by way of example and not as a limitation to the scope of the invention. Particularly, it is recognized that the teachings of the foregoing disclosure will suggest other modifications to those persons skilled in the relevant art. Such modifications may involve other features that are already known per se and which may be used instead of or in addition to features already described herein. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The Applicant hereby reserves the right to formulate new claims to such features and/or combinations of such features during the prosecution of the present application or of any further application derived therefrom.

We claim:

1. A liquified gas expansion system for cryotherapy, comprising:
an expansion chamber fluidically coupled to a liquified gas source via a liquified gas expansion valve housing, the expansion chamber housing liquified gas and expanding liquified gas;
an ambient environment conduit including a first end open to ambient environment air and a second end coupled an ambient environment valve, wherein the ambient environment valve forms a juncture between the ambient environment conduit, a reverse flow conduit and an airflow driving device intake conduit and wherein the reverse flow conduit couples the expansion chamber to the ambient environment valve;
an airflow driving device interposed between the airflow driving device intake conduit and an airflow driving device exhaust conduit and wherein the airflow driving device exhaust conduit is coupled to the expansion chamber;
a treatment environment valve interposed between an upper treatment environment conduit, a lower treatment environment conduit and the expansion chamber wherein the upper environment conduit is coupled to an upper portion of a treatment environment and the lower treatment conduit is coupled to a lower portion of the treatment environment; and
an upper environment sensor located in an upper portion of the treatment environment and a lower environment sensor located in a lower portion of the treatment environment wherein the upper environment sensor and the lower environment sensor are controllably coupled to the treatment environment valve, the ambient environment valve and the liquified gas expansion valve.

2. The liquified gas expansion system for cryotherapy of claim 1, wherein the ambient environment valve creates an ambient air expanding liquified gas mixture.

3. The liquified gas expansion system for cryotherapy of claim 2, wherein a ratio of the ambient air expanding liquified gas mixture is 4:1 expanding liquified gas to ambient air.

4. The liquified gas expansion system for cryotherapy of claim 2, further comprising an airflow driving device face airflow temperature sensor.

5. The liquified gas expansion system for cryotherapy of claim 4, wherein the ambient air expanding liquified gas mixture at the airflow driving device face airflow temperature sensor is less than negative 20 degrees Centigrade.

6. The liquified gas expansion system for cryotherapy of claim 4, further comprising a machine capable of executing instructions embodied as software and a plurality of software portions, wherein one of said software portions is configured to adjust the ambient environment valve to maintain airflow driving device face airflow temperature less than negative 20 degrees Centigrade.

7. The liquified gas expansion system for cryotherapy of claim 4, further comprising a machine capable of executing instructions embodied as software and a plurality of software portions, wherein one of said software portions is configured to monitor ambient air expanding liquified gas mixture temperature in the airflow driving device intake conduit to maintain airflow driving device face airflow temperature less than negative 20 degrees Centigrade.

8. The liquified gas expansion system for cryotherapy of claim 4, further comprising a machine capable of executing instructions embodied as software and a plurality of software portions, wherein one of said software portions is configured to receive data from both the upper environment sensor located in the upper portion of the treatment environment and the lower environment sensor located in the lower portion of the treatment environment, and control the treatment environment valve, the ambient environment valve and the liquified gas expansion valve to manipulate a volume of expansion chamber gasses delivered to the upper treatment conduit and the lower treatment conduit.

9. The liquified gas expansion system for cryotherapy of claim 1, further comprising an airflow driving device outflow airflow temperature sensor.

10. The liquified gas expansion system for cryotherapy of claim 1, wherein the airflow driving device creates a continuous flow from the expansion chamber to ambient environment valve back to the airflow driving device.

11. The liquified gas expansion system for cryotherapy of claim 1, further comprising a machine capable of executing instructions embodied as software and a plurality of software portions, wherein one of said software portions is configured to receive upper treatment environment sensor data and lower treatment environment sensor data to identify a treatment environment temperature differential and a treatment environment temperature gradient.

12. The liquified gas expansion system for cryotherapy of claim 11, further comprising a software portion configured to control the treatment environment valve, the ambient environment valve and the liquified gas expansion valve to manipulate the treatment environment temperature differential and the treatment environment temperature gradient.

13. The liquified gas expansion system for cryotherapy of claim 11, further comprising a software portion configured to control the treatment environment valve, the ambient environment valve and the liquified gas expansion valve to maintain, within the expansion chamber, a ratio of the ambient air expanding liquified gas mixture within the range of 3-4:2-1 expanding liquified gas to ambient air.

14. A method for liquified gas expansion, comprising:
fluidically coupling an expansion chamber to a liquified gas source via a liquified gas expansion valve creating an expanding liquified gas;
forming a juncture at an ambient environment valve between an ambient environment conduit, a reverse flow conduit and an airflow driving device intake conduit thereby creating an ambient air expanding liquified gas mixture wherein the ambient environment conduit includes a first end open to ambient environment air and a second end coupled to the ambient environment valve
fluidically coupling the reverse flow conduit with the expansion chamber;
driving the ambient air expanding liquified gas mixture by an airflow driving device to the expansion chamber via the an airflow driving device exhaust conduit wherein the airflow driving device is interposed between the airflow driving device intake conduit and the airflow driving device exhaust conduit;
interposing a treatment environment valve between an upper treatment environment conduit, a lower treatment environment conduit and the expansion chamber;
fluidically coupling the upper environment conduit to an upper portion of a treatment environment;
fluidically coupling the lower treatment conduit to a lower portion of the treatment environment; and
controllably coupling the treatment environment valve, the ambient environment valve and the liquified gas expansion valve to an upper environment sensor located in an upper portion of the treatment environment and a lower environment sensor located in a lower portion of the treatment environment.

15. The method for liquified gas expansion of claim 14, further comprising adjusting the ambient environment valve to maintain an airflow driving device face airflow temperature at less than negative 20 degrees Centigrade.

16. The method for liquified gas expansion of claim 14, further comprising monitoring an ambient air expanding liquified gas mixture temperature in the airflow driving device intake conduit and maintaining airflow driving device face airflow temperature at less than negative 20 degrees Centigrade.

17. The method for liquified gas expansion of claim 14, further comprising receiving, at a machine capable of executing instructions embodied as software, data from both the upper environment sensor located in the upper portion of the treatment environment and the lower environment sensor located in the lower portion of the treatment environment, and executing a software portion controlling the treatment environment valve, the ambient environment valve and the liquified gas expansion valve thereby manipulating a volume of expansion chamber gasses delivered to the upper treatment conduit and the lower treatment conduit.

18. The method for liquified gas expansion of claim 14, further comprising creating, by the airflow driving device, a continuous flow from the expansion chamber to the ambient environment valve, to the airflow driving device, to the airflow driving device exhaust conduit.

19. The method for liquified gas expansion of claim 14, further comprising receiving, at a machine capable of executing instructions embodied as software, data from both the upper treatment environment sensor data and the lower treatment environment sensor data and executing a software portion identifying a treatment environment temperature differential and a treatment environment temperature gradient.

20. The method for liquified gas expansion of claim 14, further comprising controlling the treatment environment valve, the ambient environment valve and the liquified gas expansion valve to manipulate the treatment environment temperature differential and the treatment environment temperature gradient.

21. The method for liquified gas expansion of claim 14, further comprising controlling the treatment environment valve, the ambient environment valve and the liquified gas expansion valve to maintain, within the expansion chamber, a ratio of the ambient air expanding liquified gas mixture within the range of 3-4:2-1 expanding liquified gas to ambient air.
